(19) United States
(12) Patent Application Publication
(10) Pub. No.: US 2005/0116673 A1
(43) Pub. Date: Jun. 2, 2005

(54) Methods and systems for controlling the operation of a tool

(75) Inventors: Allen A. Carl, Slingerlands, NY (US); Joshua Adams, New Hartford, CT (US); Kevin C. Craig, Saratoga Springs, NY (US); David C. Lavery, Tiverton, RI (US); Gregory Fischer, Warren, NJ (US); Stephen R. Anthony, Raleigh, NC (US); Joshua L. Hurst, Sharon Springs, NY (US); Ashish K. Modi, Troy, NY (US); David DiGiulio, Castleton, NY (US)

Correspondence Address: HESLIN ROTHENBERG FARLEY & MESITI PC, 5 COLUMBIA CIRCLE, ALBANY, NY, 12203, US

(73) Assignee: Rensselaer Polytechnic Institute, Troy, NY (US)

(21) Appl. No.: 10/826,634

(22) Filed: Apr. 16, 2004

Related U.S. Application Data
(60) Provisional application No. 60/463,973, filed on Apr. 18, 2003.

(51) Int. Cl. H02P 7/00

(52) U.S. Cl. 318/432

(57) ABSTRACT

Methods and systems for controlling the operation of a tool are provided. These methods and systems may be used to control the operation of any tool, for example, a drill or a saw. The methods and systems employ at least one sensor to detect at least one operational parameter of the tool, for example, drill speed or acceleration. Instrumentation is used to process the data representing the parameter to determine characteristic values of the parameter, for example, amplitudes and frequencies. These characteristic values are used to control the operation of the tool, to determine one or more properties of the material being acted on by the tool, or to monitor the condition of the tool. Though aspects of the invention may be applied to a broad range of tools and machining processes, in one aspect, the methods and systems are used to monitor and control the operation of a surgical drilling process, for example, for the drilling of bone.

### CROSS REFERENCE TO RELATED APPLICATIONS

This application claims priority from pending U.S. Provisional Application 60/463,973 filed on Apr. 18, 2003, the disclosure of which is incorporated by reference herein in its entirety.

### FIELD OF THE INVENTION

The present invention relates, generally, to methods, systems, and apparatus for controlling the operation of a tool, and more particularly, to controlling the operation of a tool by monitoring the motion of the tool to detect the nature of the work piece or detect variations in the work piece or tool.

### BACKGROUND OF THE INVENTION

The use and operation of a tool on a work piece must often be monitored to determine the condition of the work piece or the condition of a working surface of the tool, among other things. For instance, it is often necessary to avoid excessive material removal, for example, in grinding and polishing operations, or to avoid excessive penetration of the work piece, for example, in surgical drilling or simple home construction. In addition, it is often useful for the tool operator to be provided with evidence of tool wear, for example, as an indication of the need for servicing or the replacement of a tool. In these and many other instances it is desirable to limit the operation of the tool on the work piece to limit the penetration or damage to the work piece or, in the case of surgery, damage to the patient.

Surgeons often use what are conventionally referred to as “power tools” when operating on patients, for example, when cutting or drilling bone to correct bone structure, repair bone structure, or remove undesirable bone structure. For instance, surgeons may use specially-designed, manually-operated drills, saws, awls, reamers, and the like, on human bone tissue. In one specific surgical practice, a surgeon may use a manual power drill, for example, a specially-designed, pneumatic drill. The drill may be used to penetrate a bone to affix one or more mechanical fasteners to the bone to repair or correct an undesirable bone structure, or to stabilize a bone in response to trauma, deformity, or disease, for instance, to stabilize the spine. In the operation and use of such surgical power tools, it is critical that the surgeon maintain as much control as possible over the operation of the tool and the penetration of the tool into the tissue being manipulated. Often, under conventional practice, the surgeon must rely on the “feel” of the working surface of the power tool, for example, the drill bit, on the tissue based upon the surgeon's experience. However, any assistance the surgeon can obtain during the operation can decrease the potential for error or mishap. For example, Carl, et al. (Spine, 1997; 22:1160-1164) and Carl, et al. (Journal of Spine Disorders, 2000; 13, 3:225-229) describe the limitations of existing technology and provide a “stereotaxic” method of placing surgical fasteners by 3-dimensional remote tool detection. Though aspects of the present invention can be applied to the use and operation of any power tool, for example, industrial and residential power tools, one or more aspects of the present invention address the limitations of prior art surgical practice by providing the surgeon with at least some feedback on the nature of the tissue being penetrated by the tool.

Aspects of the present invention provide methods and systems for monitoring and controlling the operation of a tool, for example, to minimize or eliminate the potential for undesirable damage to the work piece or monitor the condition of the working surface of the tool, among other things.

### SUMMARY OF ASPECTS OF THE INVENTION

Aspects of the present invention can be used to assist a power tool operator in controlling the operation of a tool. In one aspect, the operator is provided feed-back, for example, real-time feed back, characterizing the operation of the tool, characterizing the nature of the work piece being acted upon, characterizing the state of the tool's working surface, or even to characterize or identify the material that is being worked. According to one aspect of the invention, a “smart” instrumented tool is provided that uses the detection of an operating parameter and manipulation of the operating parameter to provide useful feedback to the operator, for example, in real time, to assist the operator in the execution of the desired operation.

One aspect of the present invention is a system for controlling the operation of a tool, the system including a sensor adapted to detect at least one operational parameter of the tool and outputting at least one signal representing the at least one operational parameter; means for processing the at least one signal to detect at least one frequency of the operational parameter; and means for controlling the operation of the tool in response to the at least one frequency of the operational parameter. In one aspect of this invention, the operational parameter may be linear displacement, linear velocity, linear acceleration, rotation, rotational velocity, rotational acceleration, force, torque, voltage, or amperage. In another aspect of the invention, the operational parameter may be the sound that the tool makes when working the work piece. The tool that may be used for this system may be a drill, a saw, an awl, a reamer, a lathe, a mill, or a broach, among others. In one aspect, the means for controlling the operation of the drill may include means to stop the drill, means to stop the advancement of the drill, means to retract the drill, or means to advance the drill, among others.

Another aspect of the present invention is a method for controlling the operation of a tool, the method including: detecting at least one operational parameter of the tool; generating a signal representing the at least one operational parameter; processing the at least one signal to detect at least one frequency of the operational parameter; and controlling the operation of the tool in response to the at least one frequency of the operational parameter. In one aspect, at least one frequency comprises a plurality of frequencies. Again, the operational parameter and tool may be one of those mentioned above.

As described in co-pending provisional application 60/463,973, the inventors recognized that aspects of the present invention were not limited to industrial or residential applications, but aspects of the present invention could be applied to surgical applications, for example, the drilling of bone. Thus, other aspects of the present invention specifically apply to the control of the operation of surgical power tools. The inventors have had personal experience with the use of surgical power tools, specifically, experience using surgical drills for the drilling of vertebrae for the insertion of surgical screws, for example, for use in stabilizing the spine. The inventors have recognized a noticeable distinction between the sound that a drill bit makes when penetrating bones of varying density, for example, trabecular bone versus cortical bone. Typically, during the surgical drilling of a bone, for example, a vertebra, the pitch of the sound that the drill bit makes when penetrating bone of different density changes significantly. Recognizing this distinction, the inventors developed methods, systems, and apparatus for detecting and quantifying this change in drilling conditions, drilling performance, work piece condition, or tool condition and provided a means of providing useful feedback to the surgeon to assist the surgeon controlling the manual operation of the surgical drill. The inventors also recognized that one or more aspects of the invention are not limited to controlling the operation of a surgical drill, but may be applied to any surgical tool, manual or powered, for use on humans or any animal, for example, for saws, reamers, augers, and the like. In addition, the inventors also recognized that aspects of the present invention are not limited to surgery, but could be used for any type of tool, including industrial and residential, manual or powered.

Another aspect of the invention is a system for controlling the operation of a surgical drill on a bone, the system including: a sensor adapted to detect at least one operational parameter of the drill and outputting at least one signal representing the at least one operational parameter; means for processing the at least one signal to detect at least one frequency of the operational parameter; and means for controlling the operation of the surgical drill in response to the at least one frequency of the operational parameter. In one aspect of the invention, the bone comprises a first medium, for example, trabecular bone, and a second medium, for example, cortical bone, and the system further comprises means for detecting a transition from the first medium to the second medium. In one aspect, the system includes means to stop the drill, means to slow the advancement of the drill, means to stop the advancement of the drill, means to retract the drill, or means to advance the drill, for example, when the transition between the mediums is detected.

Another aspect of the invention is a method for controlling the operation of a surgical drill on a bone, the method including: detecting at least one operational parameter of the drill and outputting at least one signal representing the at least one operational parameter; processing the at least one signal to detect at least one frequency of the operational parameter; and controlling the operation of the surgical drill in response to the at least one frequency of the operational parameter.

Another aspect of the invention is a method for controlling the operation of a tool, the method including: detecting an operational parameter of a tool; determining a characterizing value of the operational parameter at a pre-defined frequency; comparing the characterizing value to a pre-defined threshold value of the characterizing value; controlling the operation of the tool based upon the comparison of the characterizing value to the threshold value. In one aspect, the characterizing value comprises a characterizing value of the operational parameter or the frequency of the operational parameter, for example, the amplitude, mean, variance, standard deviation, or spectral energy density.

A still further aspect of the invention is a method for identifying a material being acted on by a tool, the method including: defining at least one threshold value for a characterizing value of an operational parameter at at least one frequency for at least one material; acting on the material with the tool; detecting an operational parameter of the tool; determining at least one characterizing value of the operational parameter at the at least one predefined frequency; and comparing the characterizing value with the at least one threshold value to identify the material. Again, the characterizing value may be a characterizing value of the operational parameter or the frequency of the operational parameter, for example, amplitude, mean, variance, standard deviation, or spectral energy density.

Another aspect of the invention is an instrumented adapter for a tool including: a cylindrical main body; means for mounting the tool to the cylindrical main body; means for mounting the main body to a motive force provider for the tool; and a sensor mounted to the cylindrical main body, the sensor adapted to detect at least one operational parameter of the tool and to output a signal representative of the at least one operational parameter. In this aspect, the means for mounting the tool may comprise an adjustable chuck and the means for mounting the motive force provider to the main body may be a cylindrical projection engagable by the motive force provider. The sensor may be mounted on or in the cylindrical main body and the sensor may be adapted to output a signal via telemetry or wires.

In one aspect of the invention, the methods and systems can be used to train the tool operator, for example, train a surgical student or intern on the proper operation and use of a powered surgical tool.

Details of these aspects of the invention, as well as further aspects of the invention, will become more readily apparent upon review of the following drawings and the accompanying claims.

### BRIEF DESCRIPTION OF THE FIGURES

The subject matter that is regarded as the invention is particularly pointed out and distinctly claimed in the claims at the conclusion of the specification. The foregoing and other objects, features, and advantages of the invention will be readily understood from the following detailed description of aspects of the invention taken in conjunction with the accompanying drawings in which:

FIG. 1 is a schematic view of a tool control system according to one aspect of the invention.

FIG. 2 is a perspective view of an instrumented drill assembly according to one aspect of the present invention.

FIG. 3 is an exploded view of the drill assembly illustrated in FIG. 2.

FIG. 4 is a schematic illustration of the cross section of a bone that the drill assembly shown in FIGS. 2 and 3 may be used upon.

FIG. 5 is a representative plot of acceleration frequency spectra detected by the assembly shown in FIGS. 2 and 3 according to one aspect of the present invention.

FIG. 6 is a representative plot of filtered acceleration frequency spectrum according to one aspect of the invention.

FIG. 7 is a representative plot of filtered acceleration frequency spectrum according to one aspect of the invention.

FIG. 8 is a representative plot of variances calculated for a filtered time-domain acceleration according to one aspect of the invention.

FIG. 9 is a representative plot of variances calculated for a filtered time-domain acceleration according to one aspect of the invention.

FIG. 10 is a representative plot of variances calculated for a filtered time-domain acceleration according to one aspect of the invention.

FIG. 11 is a representative plot of variances calculated for a filtered time-domain acceleration according to one aspect of the invention.

FIG. 12 is printout of a computer screen displaying a block diagram of a digital signal processing program according to one aspect of the invention.

FIG. 13 is a perspective view of an instrumented tool assembly according to one aspect of the present invention.

FIG. 14 is a perspective view of an instrumented drill chuck shown in FIG. 13 according to another aspect of the invention.

FIG. 15 is a plan view of an instrumented drill chuck shown in FIG. 14 according to another aspect of the invention.

FIG. 16 is a right side elevation view of the instrumented chuck shown in FIG. 15 as viewed along lines 16-16.

FIG. 17 is a left side elevation view of the instrumented chuck shown in FIG. 15 as viewed along lines 17-17.

### DETAILED DESCRIPTION OF FIGURES

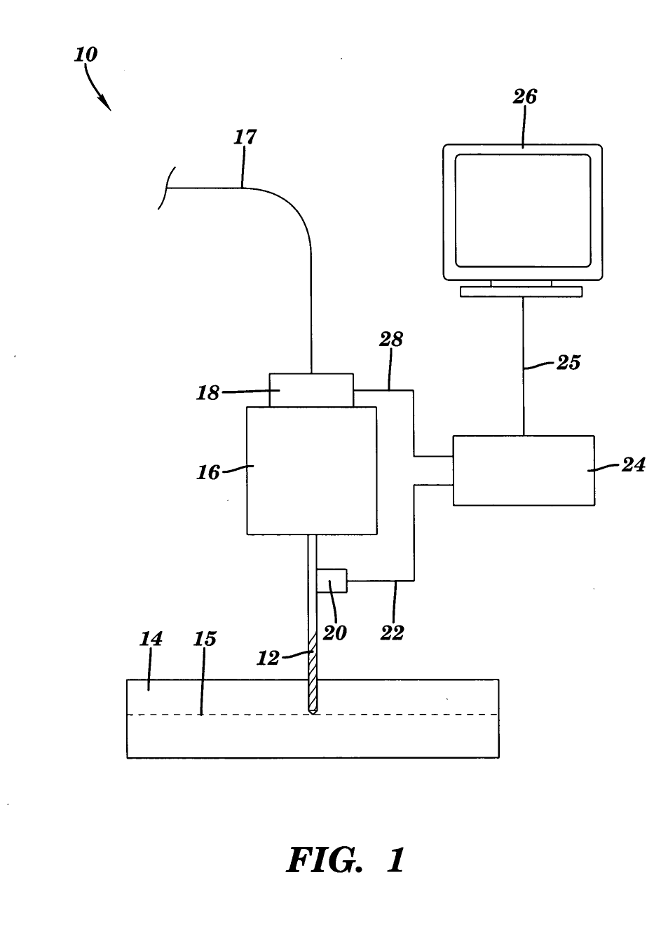

The details and scope of the aspects of the present invention can best be understood upon review of the attached figures and their following descriptions. FIG. 1 is a schematic view of a tool control system 10 according to one aspect of the invention. System 10 may be used to control the operation of a tool 12 upon a work piece 14. Though the tool 12 shown in FIG. 1 is illustrated as a simple vertical-oriented drill, it will be understood by those of skill in the art that aspects of the present invention shown in FIG. 1, and throughout this specification, may be used for any type of tool or machining operation. For example, tool 12 may be a drill, a saw, an awl, a reamer, a lathe, a mill, a broach, an auger, or a knife, among other tools, and tool 12 may be used to provide one or more of the following processes: drilling, sawing, reaming, cutting, shaping, planning, turning, boring, milling, broaching, grinding, among others. In one aspect of the invention, tool 12 may be any tool used in a cutting process, for example, a periodic cutting process. In addition, according to one aspect of the invention, the direction or orientation of tool 12 shown in FIG. 1, and shown throughout this specification, may vary and be vertically oriented, horizontally oriented, or may take any orientation in between. Also, the direction of movement of tool 12 may be upwardly, downwardly, horizontally, or any direction in between. Though tool 12 may be a broad range of tools, in the following discussion tool 12 may be referred to as “a drill” to facilitate the description of aspects of the invention.

In one aspect of the invention, work piece 14 comprises at least two materials having an interface indicated by phantom line 15 and aspects of the present invention may be used to determine when tool 12 approaches, contacts, or penetrates interface 15.

In one aspect of the invention, apparatus 10 is driven by a motive force provider 16, for example, an electric motor, having a power cord 17, or a hydraulic or pneumatic motor having a hydraulic or pneumatic conduit 17. The operation of motive force provider 16 may be controlled by controller 18, though controller 18 may simply comprise a human operator of tool 12. Motive force provider 16 may be any type of motive force providing device that can be adapted to manipulate tool 12, for example, motive force provider 16 may be an electric or hydraulic motor, an electric solenoid, a hydraulic cylinder, or pneumatic cylinder, or any other form of device that can impart motion to tool 12. Though motive force provider 16 may comprise any number of devices, to facilitate the following discussion, motive force provider 12 will be referred to as pneumatic “motor” 16 provided with compressed gas, for example, nitrogen, via conduit 17.

According to one aspect of the invention, system 10 includes a sensor 20 adapted to detect an operational parameter of tool 12, for example, the speed of rotation of tool 12, the torque applied to the work piece 14 by tool 12, or the acceleration of tool 12. In one aspect of the invention, sensor 20 is adapted to output an electrical signal, for example, via a wire or cable 22 that represents the operational parameter detected by sensor 20. For instance, sensor 20 may output a current, for example, a 4-20 milliamp (mA) current, or a voltage, for example, a 0 to 1 dc voltage (VDC), corresponding to the operational parameter detected by sensor 20. In one aspect of the invention, the signal output by sensor 20 may be transmitted without the need for a wire or conduit; for instance, sensor 20 may transmit a signal by means of telemetry, for example, by means of one or more forms of electromagnetic radiation, for example, by means of radio waves or microwaves.

In one aspect of the invention, sensor 20 may be mounted to tool 12, for example, as shown in FIG. 1. In another aspect of the invention, sensor 20 may be positioned wherever sensor 20 can detect one or more operational parameters of tool 12. For example, in one aspect of the invention, sensor 12 may be physically mounted to tool 12, to the housing of motor 16, or controller 18, or be included in a chuck (not shown) onto which or into which sensor 12 may be mounted. In another aspect of the invention, sensor 20 may be remotely mounted, for example, mounted at a distance from tool 12 or motor 16 whereby sensor 20 detects an operational parameter telemetrically, for example, by detecting a magnetic field or a magnetic field variation.

According to one aspect of the invention, the signal generated by sensor 20 may be transmitted, for example, via wire or cable 22, to some form of digital signal processor, data collection device, or data acquisition device 24. Data acquisition device 24 may comprise any form of device that is adapted to receive data transmitted by sensor 20. Data acquisition device 24 may comprise a device having one or more microprocessors, for example, a personal computer or handheld processor. In one aspect of the invention, device 24 may also include one or more controllers, for example, for controlling the operation of tool 12. In one aspect of the invention, data acquisition device 24 is adapted to receive a signal, for example, an electrical signal from sensor 20, and manipulate the signal to provide a meaningful interpretation of the signal transmitted by sensor 20. For example, device 24 may include software designed to receive a 4-20 mA signal or a 0-1 volt signal from sensor 20 and convert the 4-20 mA signal or the 0-1 volt signal to a desired operating parameter. In one aspect of the invention, the device performing the function of device 24 may be mounted on tool 12 or in tool 12 or on motor 16 or in motor 16. For example, in one aspect of the invention, device 24 may comprise a microprocessor or similar hardware providing the function of device 24. This microprocessor may comprise one or more computer chips mounted on or in tool 12 or on or in motor 16. In addition, in one aspect of the invention, the functions of sensor 20 and device 24 may be combined on to one or more microprocessors mounted on or mounted in tool 12 or on or in motor 16.

The device 24 may include means to output, store, or processes one or more signals received from sensor 20 or one or more operating parameters represented by signals received from sensor 20. For example, in one aspect of the invention, a monitor 26 is provided which receives signals transmitted over wire or cable 25. Monitor 26 may be used to display one or more operating parameters, for example, in the form of discrete data, a table of time domain data, or a plot of time-domain data or frequency domain data. In one aspect of the invention, many different display or feedback devices may be used to display the data detected by sensor 20, these include visual and audio displays. In one aspect of the invention, the data received from sensor 20 may be processed, for example, manipulated to provide a more meaningful output of the detected operating parameter. For example, in one aspect of the invention, the data received by device 24 may be processed to provide a frequency spectrum of the operating parameter, for instance, by processing the data using a Discrete Fourier Transform (DFT), a Fast Fourier Transform (FFT), or a similar or related transform.

In one aspect of the invention, device 24 may also include previously stored data to which the newly received data can be compared. For example, in one aspect of the invention, device 24 may contain previously determined data corresponding to an operating parameter or the variation in an operating parameter and the newly received data may be compared to the previously stored operating parameters and similarities or discrepancies detected and displayed to the operator, for example, to the operator of drill 12.

Device 24 may also provide means for inputting predetermined values, for example, a mouse, keyboard, voice recognition software, or other input device whereby an operator may input one or more controlling parameters. These one or more controlling parameters may provide limits or thresholds that characterized the desired or undesired operation of drill 12.

In one aspect of the invention, device 24 may include data acquisition and manipulation hardware or software, for example, an input/output (I/O) board or digital signal processor (DSP), for instance., a floating-point controller board provided by dSPACE of Paderborn, Germany, though other data acquisition hardware may be used. In one aspect of the invention, device 24 may include technical computing software, such as data manipulation and analysis software, for example, MATLAB® software provided by The Math Works, Inc. of Natick, Mass. Device 24 may also include modeling, simulation, and analysis software, such as Simulink software, which is also provided by The Math Works, Inc., though other computing, modeling, simulation, and analysis software packages may be used.

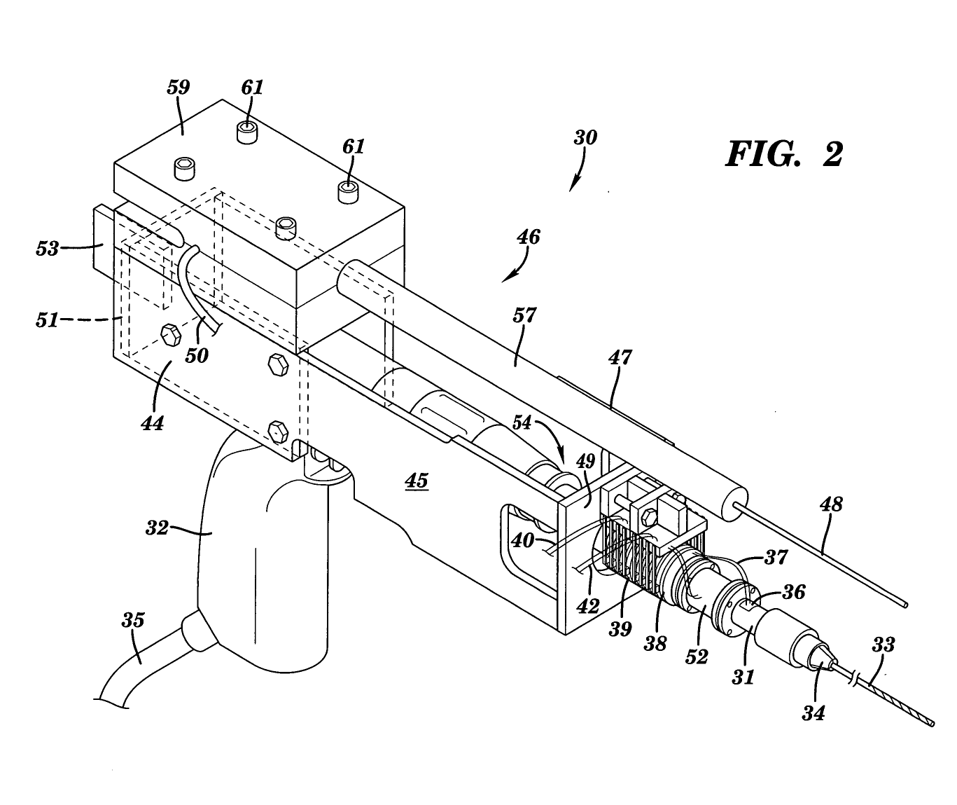

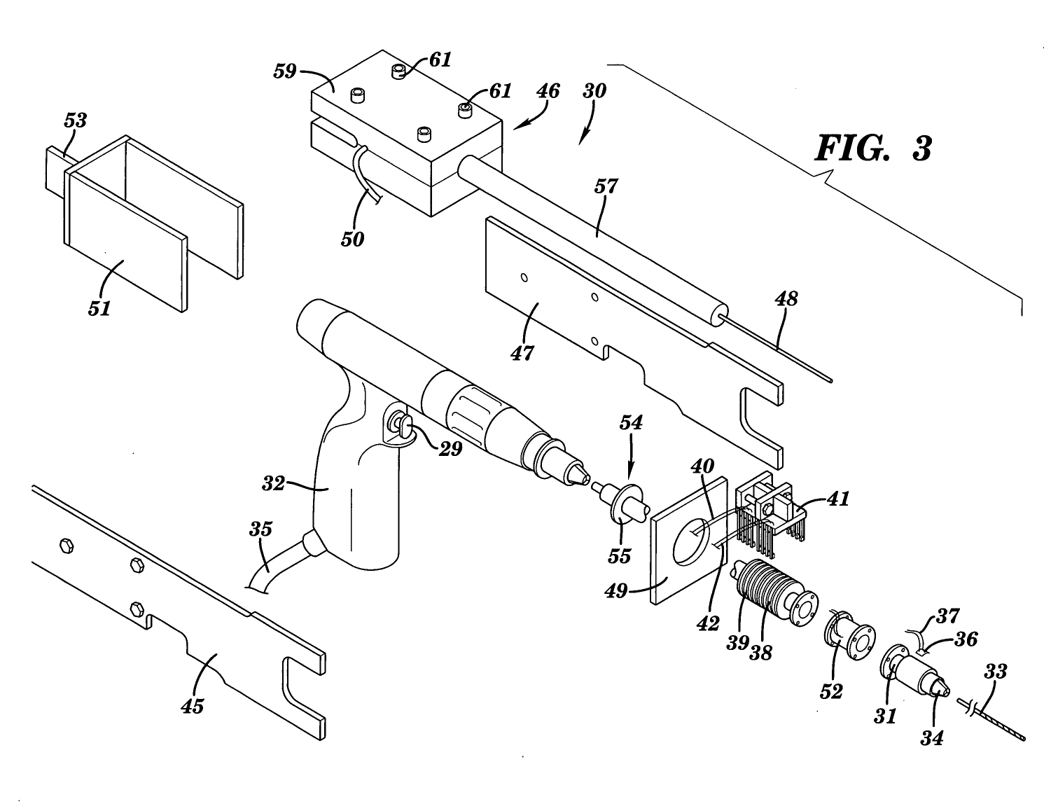

FIG. 2 is a perspective view of a proto-type drill assembly 30 according to one aspect of the present invention. FIG. 3 is an exploded view of the drill assembly 30 illustrated in FIG. 2. In this prototype device, drill assembly 30 includes a conventional surgical drill 32 having a working element or drill bit 33 mounted in a conventional drill chuck 34. Surgical drill bits are typically relatively long, for example, at least 6 inches long, and only a representative illustration is shown in FIGS. 2 and 3. The diameter of drill bit 33 may vary, but in one aspect of the invention shown, drill bit 33 is a 3/16-inch (0.1875 inch) high-speed drill bit, for example, made from conventional drill bit material, for instance, steel. Chuck 34 may be a keyed-diameter, varying-drill-bit chuck, or its equivalent. In one aspect of the invention, drill 32 may be pneumatic surgical drill provided with conventional pressurized gas via hose 35. In one aspect of the invention, hose 35 may provide nitrogen gas at about 100 psig. According to one aspect of the invention, surgical drill 32 may be a 2-speed, 2-directional Hall® Series 4 surgical drill/reamer manufactured by Zimmer and provided by Spinal Dimensions, Inc. of Albany, N.Y., though similar drills may also be used.

According to one aspect of the invention, at least one sensor 36 is mounted to drill 32 to detect at least one operating parameter of drill 32. Though according to one aspect of the invention sensor 36 may be mounted anywhere on drill 32 or on a structure mounted to drill 32 where an operating parameter may be detected, in the aspect of the invention shown in FIGS. 2 and 3, sensor 36 is mounted to the rotating shaft 31 of drill 32. In one aspect of the invention, sensor 36 may be remotely mounted and be adapted to detect one or more operating parameters of drill 32, for example, through a magnetic field detection or optical detection, among other remote means. According to one aspect of the invention, sensor 36 may comprise any sensor adapted to detect an operating parameter of drill 32. For example, sensor 36 may be adapted to detect linear displacement, speed, or acceleration; rotational displacement, speed, or acceleration; force, torque, or sound. In one aspect of the invention, sensor 36 may be adapted to detect the orientation of drill 32 or drill bit 33. For example, sensor 36 may comprise an accelerometer (for instance, a single- or multi-axis accelerometer) or an inclinometer (for instance, a fluid-in-tube inclinometer), among other devices, for detecting the angle of orientation of the drill bit 33. This aspect of the invention can be helpful, for example, to the surgeon operating a surgical drill to ensure proper alignment of the drill with the bone being operated upon.

In the aspect of the invention shown in FIGS. 2 and 3, sensor 36 is a vibration-sensing sensor, for example, having one or more accelerometers (for instance, up to six accelerometers). For instance, sensor 36 may be a single-axis or multi-axis accelerometer. In the aspect shown in FIGS. 2 and 3, sensor 36 is a model number ADXL202E dual-axis accelerometer supplied by Analog Devices of Norwood, Mass. (as described in Analog Devices ADXL202E specification sheet C02064-2.5-10/00 (rev. A), the disclosure of which is incorporated by reference herein), though any other similar or related accelerometer capable of detecting the acceleration (or vibrations) of drill 32 may be used for this invention. The one or more sensors 36 are appropriately wired, for example, with wires 37, or other wise adapted to transmit (for example, wirelessly) one or more corresponding output signals for external use, for example, recording, manipulation, display, control, or a combination of these.

In one aspect of the invention, the axis of sensor 36 may be oriented in any direction in which an operating parameter may be detected. However, in one aspect of the invention, for example, when sensor 36 comprises an accelerometer, at least one axis of sensor 36 may be oriented on drill 32 in the direction of the feed of tool 32. In one aspect of the invention, at least one axis of sensor 36 may be oriented to reduce or eliminate the influence of gravity on the sensor or on the detected signal. For example, in one aspect, when sensor 36 is an accelerometer, sensor 36 may be oriented to minimize or eliminate the effect of the acceleration due to gravity upon the detected acceleration, that is, the axis of detection of sensor 36 may be oriented perpendicular to the direction of gravity.

In the aspect of the invention shown in FIGS. 2 and 3, the one or more signals output by sensors 36 are transmitted via wires 37 to one or more slip-ring assemblies (or simply “slip rings”) 38, 39. In one aspect of the invention, one or more slip rings 38, 39 may be Model 1908 slip-rings, having a 1-inch bore, supplied by Fabricast Inc. of South El Monte, Calif., though other similar or comparable slip-rings may be used. Slip rings 38, 39 transmit the output signals from sensors 36 to a mating slip ring stator 41, and then, via wires 40 and 42, to an external receiver, for example, a processing or storage device (not shown) such as device 24 shown in FIG. 1. In the aspect shown, wires 40 and 42 transmitted signals to an interface board, specifically, to a dSpace floating-point controller board connected to a personal computer or other digital signal processor (DSP).

Prototype drill assembly 30 also included a support housing 44, though in one aspect of the invention, no support housing 44 is required. Housing 44 is mounted to drill 32 to provide a convenient structure to mount hardware or wiring, for example, to provide a stable mounting for slip ring stator 41. Housing 44 may be mounted to drill 32 by means of mechanical fasteners, though in one aspect of the invention, housing 44 may be mounted to drill 32 by welding or housing 44 may be fabricated as an integral part of drill 32. In one aspect of the invention, housing 44 may be metallic or non-metallic. For example, housing 44 may be made from steel, stainless steel, aluminum, titanium, or any other structural metal; or housing 44 may be made from polyethylene (PE), polypropylene (PP), polyester (PE), polytetraflouroethylene (PTFE), acrylonitrile butadiene styrene (ABS), among other plastics. Housing 44 may be fabricated or machined from plate, cast, forged, or fabricated by welding or gluing appropriately sized plate. In the aspect of the invention shown in FIGS. 2 and 3, housing 44 is fabricated from three aluminum plates 45, 47, and 49 and an adapter piece 51 assembled by means of mechanical fasteners and fastened to drill 32 by a plurality of mechanical fasteners, specifically, nuts and bolts. Adapter piece 51 may be provided having a projection 53 for grasping and positioning drill assembly 30, for example, for robotic manipulation. Housing 44 may typically be provided with appropriate cut-outs and perforations to permit access to instrumentation and wiring, and to provide unhindered access to the handle and trigger 29 of drill 32 by the operator or surgeon as needed.

As shown in FIGS. 2 and 3, drill assembly 30 may also include one or more other sensing devices, alone or in conjunction with sensor 36. For example, in one aspect of the invention, drill assembly 30 may also include a sensor for detecting the torsion in the drill shaft 34, for instance, a torque sensor 52, for example, a torque cell provided by FUTEK Advanced Sensor Technology, of Irvine, Calif., though other torque sensors may be used. As shown in FIGS. 2 and 3, torque sensor 52 may be flanged device for mounting to adjacent components. Also, drill assembly 30 may also include one or more sensors for detecting the rotational speed of drill shaft 34, for instance, a speed sensor 54, for example, an optical encoder speed sensor have a sensing disk 55 provided by U.S. Digital Corporation of Vancouver, Wash., though other similar or different speed sensors may be used.

In one aspect of the invention, drill assembly 30 may also include a Linear Variable Differential Transformer (LVDT) 46. LVDT 46 may be used to assist the operator in monitoring and controlling the operation of drill 32, for example, to monitor and control the depth of penetration of drill 33 into a bone or other material. LVDT 46 typically includes a barrel 57 having a telescoping probe 48 and base housing 59 including the electrical interface. Housing 59 may be mounted to drill 32 or to housing 44 by means of one or more mechanical fasteners, for example, cap screws 61. The output signal from LVDT 46 is transmitted via wire 50. In one aspect of the invention, LVDT 46 may comprise a DCT2000A DC Spring Return LVDT supplied by RDP Electronics Ltd. of Wolverhampton, West Va., though other LVDTs may be used.

As will be discussed below, the prototype device 30 shown in FIGS. 2 and 3 was used to investigate aspects of the present invention. As will also be discussed below, prototype device 30 includes many features that typically characterize a device used for experimental or evaluation reasons, for example, it will be apparent to those of skill in the art that the design of device 30 has not been optimized to enhance its operation, usability, or marketability, among other things. Enhancements to device 30 will be discussed below.

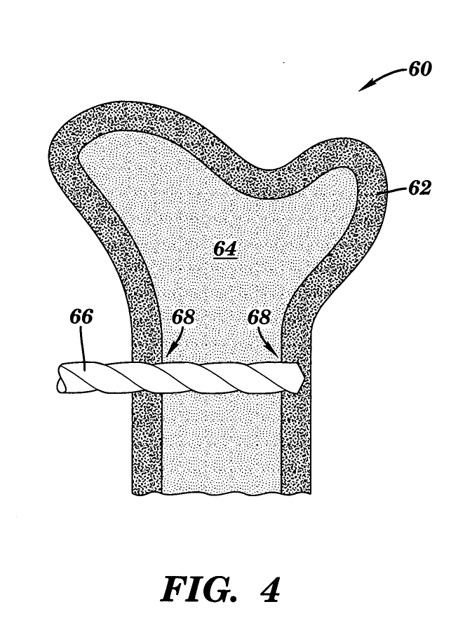

FIG. 4 is a schematic illustration of the cross section of a bone 60 that aspects of the present invention, for example, drill assembly 30 shown in FIGS. 2 and 3, may be used to drill. FIG. 4 illustrates a typical bone structure, both human and animal, in which bone 60 comprises a dense outer layer 62, that is, the cortical bone, and a less dense inner portion 64, that is, the trabecular bone. Also shown in FIG. 4 is a representative drill bit 66, for example, a drill bit similar to drill bit 33 shown in FIGS. 2 and 3. According to aspects of the present invention, drill assembly 30 shown in FIGS. 2 and 3 can be used to, among other things, detect the nature of the bone through which drill bit 66 is passing, for example, cortical bone 62 or trabecular bone 64, or detect the transitions between one medium and another medium, as indicated by transitions 68 in FIG. 4.

Since the inventors had difficulty obtaining suitable human or animal bones upon which to experiment. They sought alternative materials having material properties that could suitably represent bone tissue. The inventors learned from Hayes, et al. (“Biomechanics of Cortical and Trabecular Bone: Implications for assessment of Fracture Risk”, Basic Orthopaedic Biomechanics, 2^{nd} ed, 1997) that fiber re-enforced engineering composites have mechanical features similar to cortical bone and that porous engineering foams have mechanical features similar to trabecular bone. Therefore, in lieu of human or animal bone tissue, the inventors investigated the present invention as applied to these engineered materials.

The apparatus illustrated in FIGS. 2 and 3 was used by the inventors to evaluate aspects of the present invention. Two materials were chosen to obtain data representing bone of different densities: (1) a fiber re-enforced engineering composite (herein, “the composite”), specifically, a layered fiberglass, having a thickness of about ½ inch, was used to simulate cortical bone; and (2) a porous engineering foam (herein, “the foam”), specifically, a packing foam, having a thickness of about 1 inch, was used to simulate trabecular bone.

In the trials performed according to this aspect of the invention, the operational parameter detected was the acceleration (or vibration) of shaft 31 (see FIGS. 2 and 3) while drilling the composite and the foam. Though according to aspects of the invention, the operational parameter of the drill in any direction may be detected, in the trials performed on the representative engineering materials, the axial acceleration of the drill (that is, in the direction of the drilling) was detected using an ADXL202E dual-axis accelerometer supplied by Analog Devices. According to the present invention, the acceleration of the drill was processed using a dSpace Model 1102 floating-point control board to receive data collected from slip rings 38, 39. The acceleration data was then processed using a Fast Fourier Transform (FFT) tool provided in MATLAB® mathematical programming language and environment on a personal computer. The FFT provided a frequency spectrum (or a power spectrum density (PSD)) for the acceleration detected by sensor 36, that is, the accelerometer. In the trials, a data set length for 256 points was used for the FFT and the bandwidth of accelerometer was 5 kHz; therefore, the acceleration was sampled at 10 kHz to avoid aliasing. As a result, the FFT provided a frequency spacing of 100 Hz. The inventors found this spacing to be satisfactory, especially, since some filtering would be used as discussed below.

In the trials, the 256 sample points correspond to about 0.0256 seconds per sample. For each trial, the data was collected for about 1 second. Having 256 sample points for the FFT, the inventors were able to average several FFTs for each trial.

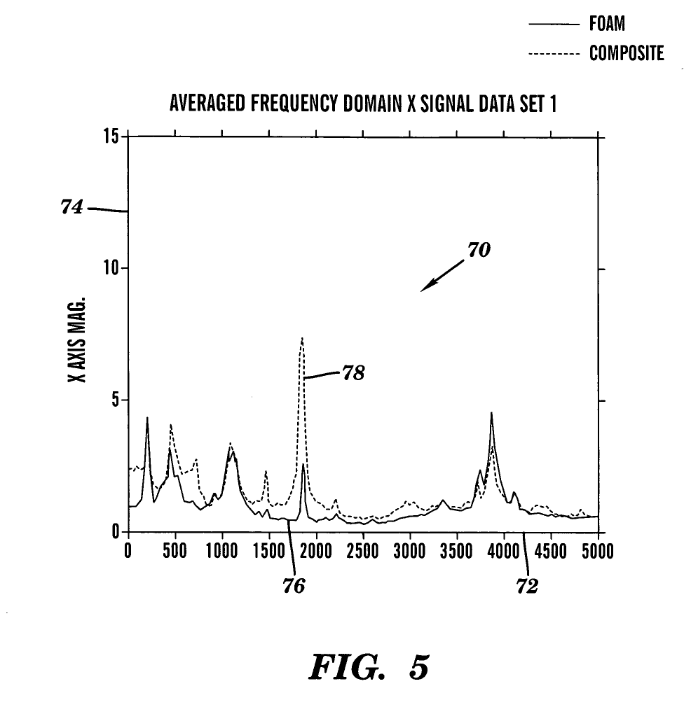

In the trials, the output of the FFT the MATLAB/Simulink software was configured to provide a plot of a frequency spectrum (that is, a PSD) illustrating the frequencies of the acceleration that characterized the drilling of the respective material. Multiple trial drillings were performed on the composite and multiple trial drillings were performed on the foam. A representative frequency spectrum 70 for the two materials appears in FIG. 5. In FIG. 5, acceleration frequency in Hz is displayed on the abscissa 72 and the magnitude of the respective frequencies are displayed in the ordinate 74. The frequency spectrum for the foam is shown as curve 76 and the spectrum for the composite is shown as curve 78. These spectra shown in FIG. 5 correspond to the average values of several trials, for example, at least 3 trials, and may be the average of at least 10 trials. The spectra for each respective material were similar for each trial. The curves in FIG. 5 clearly indicate that the frequency spectra of the acceleration of the tool when drilling materials of different densities are different, that is, include distinct different peaks and valleys.

The inventors then performed further trials in which spindle speed and feed rate of the drill were varied to determine their respective effects upon the acceleration frequency spectra. The inventors found that spindle speed had little or no effect upon the frequency spectra for either material. The inventors also found that variations in feed rate did produce a notable damping effect upon the spectra for the composite, but this damping effect was only noticeable when a contact force between the drill and the material was relatively large.

According to one aspect of the invention, frequency spectra, such as shown in FIG. 5, may be used to characterize or identify the material being machined or the condition of a tool, for example, the condition of the working surface of drill 12, in FIG. 1, or drill 33, in FIGS. 2 and 3.

Once the frequency spectra shown in FIG. 5 were identified, the inventors examined specific ranges of frequencies to better understand the differences between the spectra for the two materials. In reviewing the spectra shown in FIG. 5, the inventors recognized that the characteristics of the frequency spectra were markedly different at different frequencies. Specifically, the spectrum for the composite compared to the spectrum of the foam included a noticeable “spike” or resonant frequencies in the frequency range between about 1500 and 2000 Hz and the spectrum for the foam include more “activity” at a frequency near 0 Hz compared to the spectrum for the composite. Therefore, the inventors investigated these areas of the spectra by designing two digital filters: one to isolate the frequencies where the drilling of the foam was more active, and one to isolate the frequencies where the drilling of the composite was more active.

The inventors found that the frequency spectrum for the drilling of the foam had relatively more activity at the low frequencies. The inventors surmised that this increased activity could be caused by the drill itself (that is, as compared to the drill's interaction with the foam) since there is a similar amount of behavior when the drill is rotated in air, that is, when not in a material. The inventors further surmised that this low frequency energy may be damped out when drilling the denser composite. That is, when drilling the less dense foam, these accelerations are not attenuated as in the denser composite.

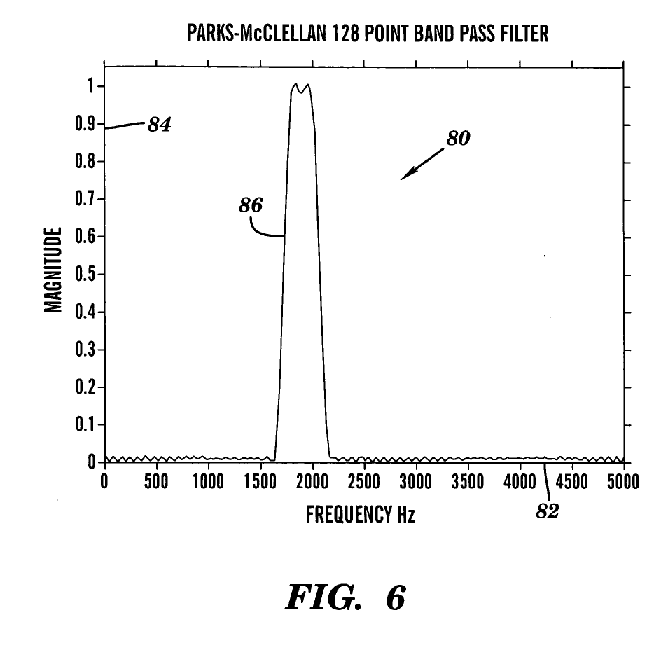

The inventors also found that analysis of the spectrum from the drilling of the composite could be characterized by isolating the spectrum in a specific frequency range, specifically between 1600 to 2200 Hz. Since this frequency range is relatively small, a Parks-McClellan equi-ripple filter was used. The filter was designed using the “remez” command tin MATLAB and a 128-point filter was chosen. The resulting filtered signal 80 is shown in FIG. 6 for the composite. In FIG. 6, acceleration frequency in Hz is displayed on the abscissa 82 and the magnitude of the respective frequencies are displayed in the ordinate 84. The filtered frequency spectrum for the composite is shown as curve 86.

The fine resolution of the sampling is reflected in the sharp edges of curve 86 in FIG. 6. Curve 86 required a very fast sampling frequency of 10 kHz per minute. Having such a fast sampling frequency, the time delay of 0.0128 seconds used in this analysis did not adversely affect the system.

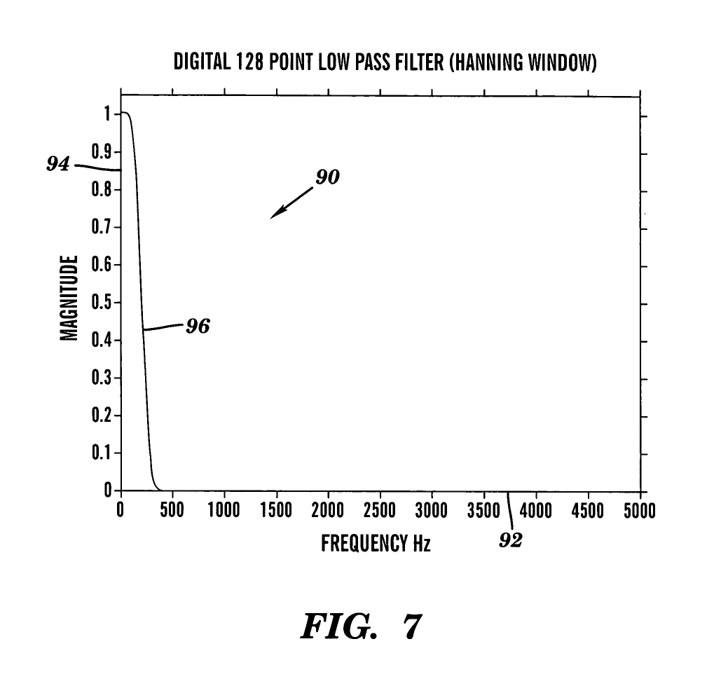

The inventors also designed a low pass filter using a digital implementation of a Hanning Window Low Pass Filter, which is simpler than a Parks-McClellan filter. This filter was used to generate the frequency spectrum 90 shown in FIG. 7 for the foam. In FIG. 7, acceleration frequency in Hz is displayed on the abscissa 92 and the magnitude of the respective frequencies are displayed in the ordinate 94. The frequency spectrum for the filtered acceleration for the foam is shown as curve 96.

Since the activity of the frequency spectra for the two materials were so markedly different in shape and magnitude, among other things, the inventors realized that this “activity” of the respective spectra at the frequency ranges shown in FIGS. 6 and 7 could be used to characterize the material being drilled, for example, to identify the material being drilled, to identify transitions between materials, to determine the thickness of materials, or to indicate damage or wear to the working surface of the tool. The inventors also realized that the respective activity of the frequency spectra could be quantified and differentiated by using one or more numerical properties or characteristics of the spectra in these active regions, for example, the amplitude of the spectra, the variance of the spectra, the standard deviation of the spectra, or the spectral energy density of the spectra (that is, the area under the spectra in a frequency range of interest), among other data. According to aspects of the present invention, one or more of these numerical properties of the spectra can be used to characterize the nature of the material being machined, for example, drilled.

The inventors further realized that knowing the excitation or resonant frequency associated with the material being worked, the time domain frequency of the drilling could also be used as an indicator to characterize the material being worked. For example, for the composite, having an excitation frequency in the range of 1600 to 2200 Hz as indicated in FIG. 6, any time domain activity in these frequency ranges could be used as an identifier or “trigger” for the material being drilled. For example, according to one aspect of the invention, identifying any time-domain operational parameter (for example, acceleration) activity at, for example, a frequency of 1800 Hz, can be an indication that the material being drilled is the composite, or at a frequency if about 100 Hz, can be an indication that the material being drilled is the foam. The inventors also realized that the respective activity of the time-domain acceleration could be quantified and differentiated by using one or more numerical properties of the time domain acceleration data at these frequencies, for example, the amplitude of the acceleration data, the mean of the acceleration data, the variance of the acceleration data, the standard deviation of the acceleration data, or the spectral density of the time-domain acceleration data (that is, the area under the acceleration curve at a frequency of interest), among other data. According to aspects of the present invention, one or more of these numerical properties of acceleration data, or of any operational parameter discussed above, can be used to characterize the nature of the material being machined, for example, drilled.

In the experimental trials discussed above, the inventors chose to use the variance of the time-domain acceleration data at a specific frequency as an indicator of the material being drilled. The inventors chose to examine variance of the time-domain acceleration for the accelerations having a frequency of 1800 Hz. In the variance calculation, a buffer was chosen as a large number of points to account for variation in frequency content and the shorter time duration FFT analysis. The inventors noticed that the frequency content of the vibration (that is, acceleration) varied significantly over small periods of time. The inventors found that the 1024-point buffer translates to less than 0.10 seconds of real time.

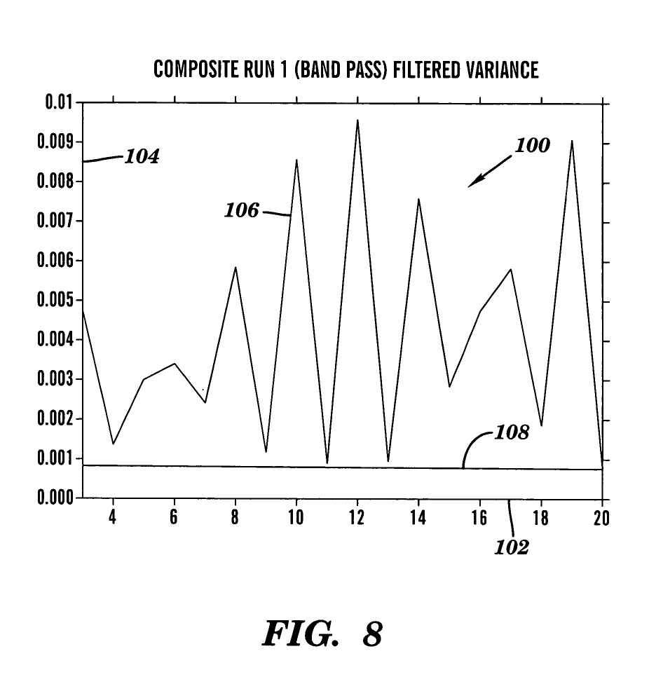

FIG. 8 displays computed variances 100 for the time-domain acceleration filtered to isolate the 1800 Hz acceleration for the composite. In FIG. 8, a representative sample number is displayed on the abscissa 102 and the magnitude of the variance in raw, unconverted volts from the accelerometer are displayed in the ordinate 104. The variation of the variance at this filtered frequency for the composite is shown as curve 106. Clearly, as shown in FIG. 8, the acceleration in the time-domain at this frequency contains a definite variance indicating some activity for the acceleration at the frequency of 1800 Hz. According to one aspect of the invention, a threshold value of the variance in the time domain can be selected to indicate activity in the acceleration data at 1800 Hz. For example, as shown in FIG. 8, horizontal line 108 represents the threshold value of the variance of 0.00075 volts.

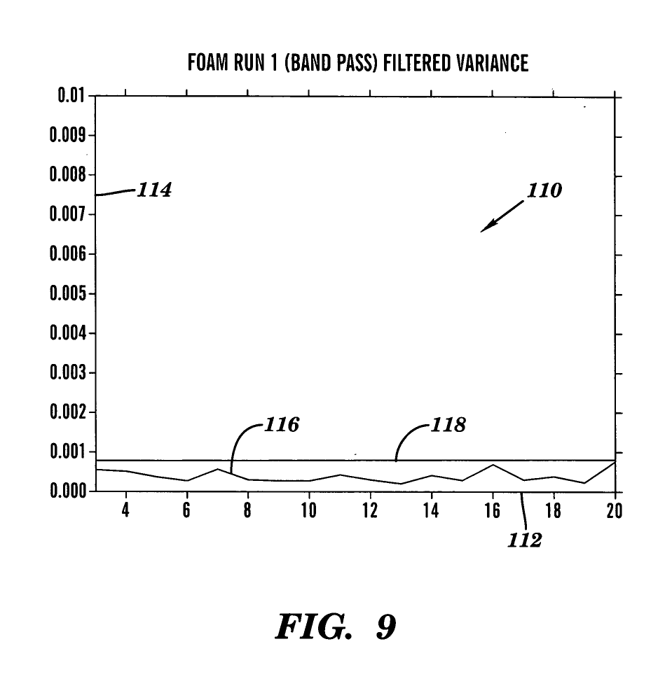

In contrast, the acceleration data for the foam does not manifest the activity at 1800 Hz that the composite did. This is shown in FIG. 9. Similar to FIG. 8, FIG. 9 displays computed variances 110 for the time-domain acceleration filtered to isolate the 1800 Hz acceleration for the foam. In FIG. 9, a representative sample number is displayed on the abscissa 112 and the magnitude of the variance in raw, unconverted volts from the accelerometer are displayed in the ordinate 114. The variation of the variance at this filtered frequency for the foam is shown as curve 116. Clearly, in contrast to FIG. 8, the acceleration in the time-domain at this frequency contains little or no activity for the acceleration at the frequency of 1800 Hz for the foam. Also shown in FIG. 9 is a threshold line 118 corresponding to the threshold value of the variance of 0.00075 volts, similar to FIG. 8. Clearly, the variance of the time-domain acceleration at 1800 Hz for the foam is less than this threshold value.

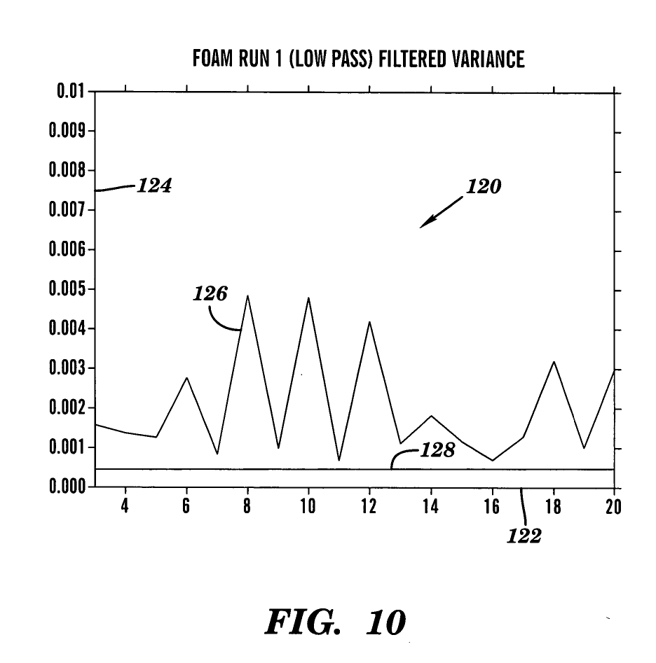

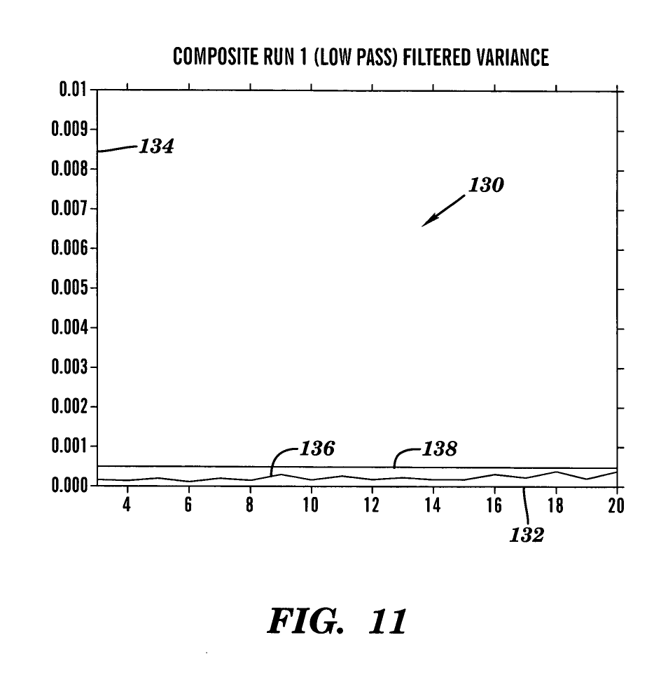

Similar variance data for the frequency below 200 Hz are shown in FIGS. 10 and 11. FIG. 10 displays computed variances 120 for the time-domain acceleration filtered to isolate accelerations below 200 Hz for the foam. In FIG. 10, a representative sample number is displayed on the abscissa 122 and the magnitude of the variance in raw, unconverted volts from the accelerometer are displayed in the ordinate 124. The variation of the variance at these filtered frequencies for the foam is shown as curve 126. Clearly, as shown in FIG. 10, the acceleration in the time-domain at this frequency contains a definite variance indicating some activity for the acceleration at the frequencies below 200 Hz for the foam. Again, a threshold value of the variance in the time domain can be selected to indicate activity in the acceleration data at frequencies less than 200 Hz. For example, as shown in FIG. 10, horizontal line 128 represents the threshold value of the variance of 0.0005 volts.

In contrast, the acceleration data for the composite does not manifest the activity at less than 200 Hz that the foam did. This is shown in FIG. 11. Similar to FIG. 10, FIG. 11 displays computed variances 130 for the time-domain acceleration filtered to isolate accelerations at less than 200 Hz for the composite. In FIG. 11, a representative sample number is displayed on the abscissa 132 and the magnitude of the variance in raw, unconverted volts from the accelerometer are displayed in the ordinate 134. The variation of the variance at this filtered frequency for the composite is shown as curve 136. Clearly, in contrast to FIG. 10, the acceleration in the time-domain at this frequency contains little or no activity for the acceleration at frequencies less than 200 Hz for the composite. Also shown in FIG. 11, is a threshold line 138 corresponding to the threshold value of the variance of 0.0005 volts, similar to FIG. 10. Clearly, the variance of the time-domain acceleration at frequencies less than 200 Hz for the composite is less than this threshold value.

According to one aspect of the invention, a comparison of the variance of an operational parameter, for example, linear displacement, rotational speed, linear acceleration, sound, etc. in the time domain at a frequency, or at a range of frequencies, with a threshold value can be used as a positive indication of the nature of the material being drilled, a transition between materials, the length of penetration, the thickness of the material, or an indication of the relative condition of the tool, for example, the condition of the working surface of the tool.

In one aspect of the invention, when a material is recognized, a material transition is detected, or an undesirable tool condition is detected, the operator may be notified. This notification may be effected visually, for example, by means of an illuminated indicator; audibly, for example, by means of a tone, bell, or alarm; or by means of a combination of a visual and an audible signal. In one aspect of the invention, a material type or tool condition may be displayed on a monitor, for example, “Entering cortical bone”; “Metal barrier detected”; “Tool wear detected”, “Tool misalignment detected”; or “Southern Softwood”, among other displays. Such phrases may also be audibly announced with or without visual notification.

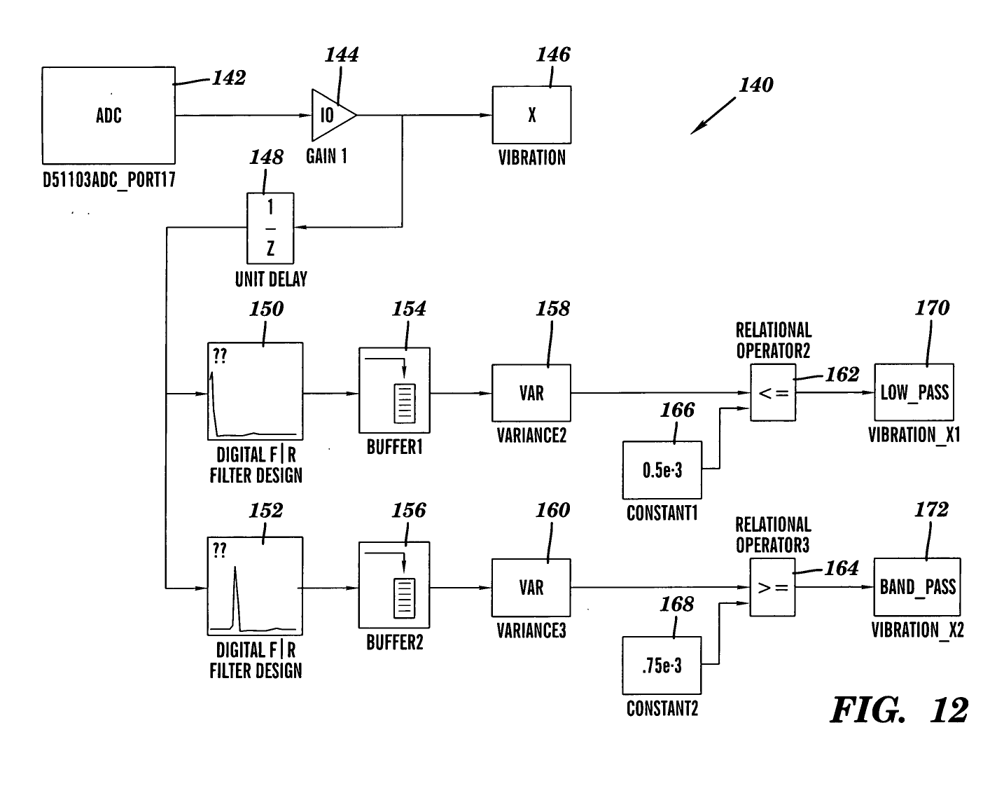

FIG. 12 is printout of a computer screen displaying a block diagram 140 of a digital signal processing program according to one aspect of the invention. In the trials performed using the prototype shown in FIGS. 2 and 3, the accelerometer signal was transmitted from the slip rings 38, 39 to a digital signal processor (DSP), specifically, a dSpace DSP, and then transmitted to a personal computer for manipulation and output. The block diagram 140 shown in FIG. 12 was created using MATLAB/Simulink data manipulation and analysis software. The block diagram 140 includes a block 142 representing the computer interface receiving the acceleration signal from the signal processor. Amplifier 144, having a typical gain of 10, amplifies the received signal to provide an amplified acceleration (or vibration) signal which can be accessed through block 146. The amplified signal is then passed through a time delay 148 and then passed to two filters 150 and 152. Filter 150 represents the Hanning Window Low Pass Filter and filter 152 represents the Parks-McClellan equi-ripple digital band-pass digital filter, both mentioned above. According to the present invention, at least one filter 150 or filter 152 may be provided, but in one aspect of the invention, one or more low-pass filters 150 and one or more band-pass filters may be provide, for example, to isolate at least one, preferably, two or more, resonant frequencies of two or more materials.

The filtered data is then stored in buffers 154 and 156, respectively. The data stored in buffers 154, 156 is then used to calculate respective variances in blocks 158 and 160, respectively. As discussed above, the variance may be calculated for the time-domain data or the frequency domain data. In one aspect of the invention, the variances determined in blocks 158 and 160 can be compared with threshold values, for example, predetermined threshold values, in relational operator blocks 162 and 164, respectively. The threshold values, for example, the voltage vales 0.0005 volts and 0.00075 volts discussed above, may be stored in blocks 166 and 168, respectively. The results of this comparison may be displayed by blocks 170 and 172, respectively. Blocks 170 and 172 may simply indicate a positive condition, for example, a variance less than or greater than a specified threshold, and, for example, activate one or more audible or visual signals, as discussed above. Blocks 170 and 172 may display, record, or store the variances and their relationship to the threshold values, for example, for future review or use. Blocks 170 and 172 may also correspond to more complex functions depending upon the type and use of the tool being monitored. For example, blocks 170 and 172 may stop the operation of the tool, may slow the advancement of the tool, may stop the advancement of the tool, may retract the tool from the work piece, or may advance the tool into the work piece, among other actions.

In one aspect of the invention, a plurality of filtering blocks 150, 152 may be provided corresponding to a plurality of frequencies. For example, in one aspect of the invention a plurality of band-pass filters may be provided each configured to an excitation frequency associated with a material. For example, frequency A may correspond to bone; frequency B may correspond to cartilage; frequency C may correspond to titanium; and frequency D may correspond to eucalyptus wood, among other materials. According to one aspect of the invention, an instrumented tool may be used to determine an excitation frequency for a material whereby a library of excitation materials and respective frequencies can be determined and stored for future use. These excitation frequencies may not only be material specific, they may also be tool specific. For example, cortical bone may have a corresponding excitation frequency for drilling, for sawing, for reaming, and for any of the other operation mentioned above. In addition, cortical bone may have a corresponding excitation frequency for drilling with a specific diameter drill bit, or drilling with a specific drill bit material, or drilling with a specific drill type, among other variables. In addition to obtaining a plurality of excitation frequencies, a plurality of threshold values may be determined and stored for future reference. Those of skill in the art will recognize that an excitation frequency, and a corresponding threshold value, may be determined for any variable of the tool that affects the excitation frequency or the magnitude of an operational parameter.

In one aspect of the invention, the apparatus according to the present invention, for example, shown in FIG. 1, 2, 12 or 14, may include the capability to “learn”. For example, in one aspect of the invention, while an instrumented tool according to the present invention works on a material, the instrumentation may have the ability to detect and analyze the operational parameter and determine the excitation frequency, or an excitation frequency and threshold value, for the material being worked. This learning capability may be provided after a single use of the tool on the material or a plurality of uses. In addition, the instrumentation and related software may be provided to repeatedly monitor the operational parameter, for example, continually monitor the operational parameter, whereby the excitation frequency or threshold value may be repeatedly determined and compared to existing frequencies and thresholds, and, if necessary, updated as needed.

According to one aspect of the invention, the detection and processing of an operating parameter may be used to control the operation of a tool. In one aspect, the detection and processing of operating parameter is used to stop the operation of the tool. For example, one or more characteristics or values in the time domain or frequency domain may be used to trigger the disconnecting of power from an electrically-powered tool, or termination of fluid pressure to a hydraulically or pneumatically powered tool. In one aspect of the invention, the triggering event of the data processing may activate a solenoid that redirects or shuts off the flow of a fluid, such as a gas or liquid, to a tool. In another aspect of the invention, the triggering event may activate a brake or clutch mechanism that slows or stops the movement (for example, translation, rotation, or reciprocation) of a tool. This brake or clutch mechanism may comprise an active engagement or disengagement of the moving tool or of a part associated with the moving tool to at least slow, but preferably stop, the movement of the tool, for example, by means of a friction surface or brake pad. The triggering event may activate the brake or clutch function electronically, for example, by means of solenoid; hydraulically or pneumatically, for example, by means of a valve and piston; or mechanically, for example, by means of a linkage. In one aspect, of the invention, the triggering event may cause the tool to be removed from the work piece, for example, with or without the stopping of the working motion of the tool.

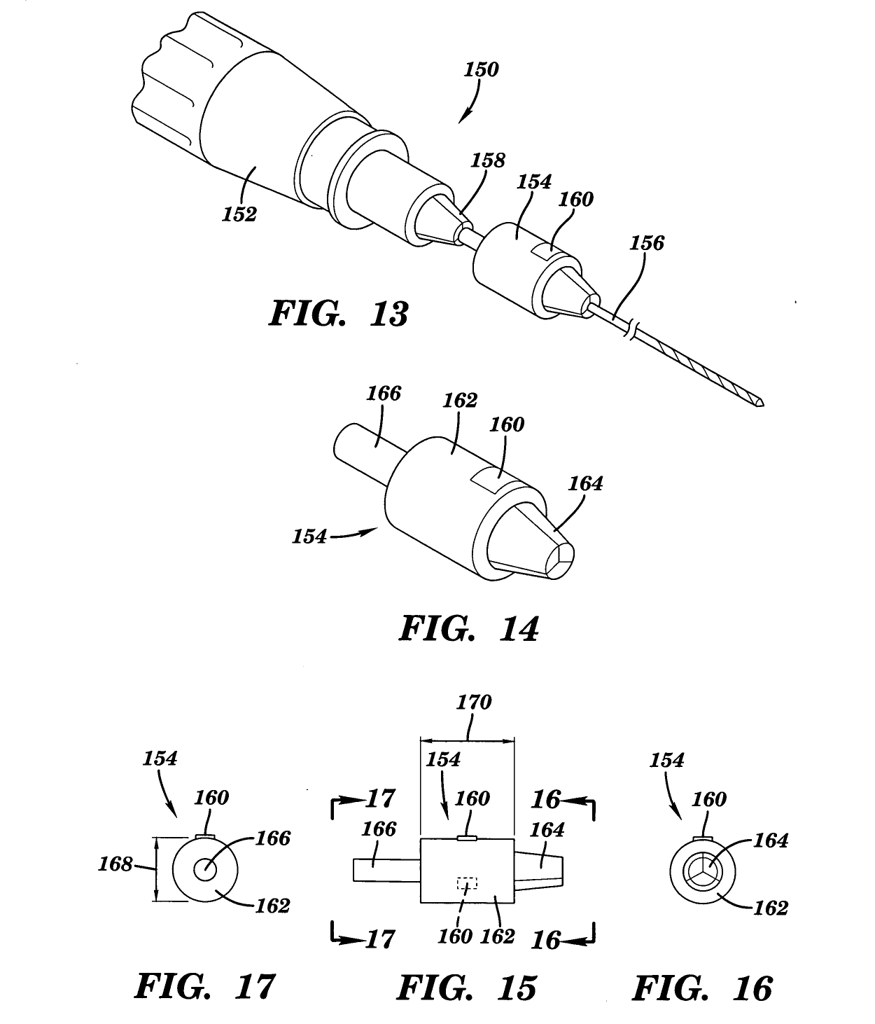

FIGS. 2 through 12 illustrate aspects of the present invention that were used to develop and prove the validity of the present invention, that is, these apparatus comprise prototypes. However, the inventors recognize that aspects of the present invention may be implemented in more refined designs which take advantage of the known capabilities of hardware and software. These aspects of the present invention are illustrated in FIGS. 13 though 17.

FIG. 13 is a perspective view of an instrumented tool assembly 150 according to another aspect of the present invention. Assembly 150 includes a drill 152 (only a portion of which is shown in FIG. 13) and an instrumented adapter or drill chuck 154, according to one aspect of the invention, holding a drill bit 156. Instrumented adapter 154 may be mounted in the jaws 158 of drill 152 in a conventional manner. According to this aspect of the invention, instrumented adapter 154 includes at least one sensor assembly 160. Though in the aspect of the invention shown in FIG. 13, instrumented adapter 154 having sensor assembly 160 is shown as a separate chuck, that is, separate and distinct from drill 152, in one aspect of the invention, sensor assembly 160 may be mounted to drill 152. That is, in one aspect of the invention and instrumented drill 152 having sensor assembly 160 is provided.

In one aspect of the invention, sensor assembly 160 includes at least one sensor for detecting one or more operational parameters, for example, linear acceleration or rotational speed, among others. In one aspect of the invention, sensor assembly 160 includes at least one accelerometer, for example, the Analog Devices ADXL202E dual-axis accelerometer discussed above. In one aspect of the invention, sensor assembly 160 may transmit one or more signals to an external receiver or signal processor by one or more wires or cables (not shown), for example, via one or more slip rings or similar devices (also not shown). However, in the aspect of the invention shown in FIG. 13, no wires or cables may be necessary; that is, sensor assembly 160 may be “wireless”. For instance, sensor assembly 160 may include the capability to transmit one or more signals corresponding to one or more operational parameters telemetrically. For example, sensor assembly 160 may transmit one or more signals via radio waves (RF), microwaves, or by means of any other electromagnetic radiation. According to one aspect of the invention sensor assembly 160 may transmit signals via Bluetooth® wireless technology or Asterisk™ wireless technology, among others. In one aspect of the invention, the telemetrically transmitted signals may be remotely received and processed, as described above, and, for example, to control the operation of drill 152 accordingly.

In another aspect of the invention, sensor assembly 160 may include signal processing capability whereby at least some, if not all, of the signal processing is performed by sensor assembly 160. In this aspect of the invention, sensor assembly 160 may include at least one microprocessor for processing the operational parameter detected by sensor assembly 160. This at least one microprocessor may be programmed as described above. For example, the at least one microprocessor in sensor assembly 160 may include a filtering capability, may include a data manipulation capability (for example, to compute variances), and may include the capability to store and utilize one or more threshold valves as discussed above (for example, threshold values for variance). The results of this data processing may comprise a notification of the operator, for example, an audible or visual signal as discussed above, or a change in the operation of tool 152. In one aspect of the invention, the output of the data processing in sensor assembly 160 may be transmitted to a controller that controls the operation of drill 152 either telemetrically or via one or more wires (for example, via slip rings, not shown). For example, in one aspect of the invention, the output from sensor assembly 160 may be forwarded (again, either telemetrically or via one or more wires) to a controller mounted on, in, or adjacent to drill 152.

In one aspect of the invention, sensor assembly 160 comprises a controller for controlling the operation of drill 152. That is, sensor assembly 160 may include the capability of controlling the operation of drill 152 or the operation of drill bit 156. For example, in one aspect of the invention, sensor assembly 160 may include a controller that transmits a signal (again, telemetrically or via one or more wires) to drill 152 or to an actuator controlling the operation of drill 152, for example, to a solenoid valve which regulates the flow of pressurized gas to, for example, the pneumatic drill 152. Adapter 154 may also include a protective housing (not shown) mounted over sensor assembly 160, for example, a thermally-encased protective housing, to minimize or prevent damage to sensor assembly 160.

In one aspect of the invention, instrumented adapter or chuck 154 comprises means for controlling the operation of drill bit 156. For example, in one aspect of the invention, instrumented adapter 154 includes a brake or clutch mechanism, for example, an electrical, pneumatic, or hydraulic mechanism, that engages or disengages to control the rotation of drill bit 156 in response to the data detection, processing, and control discussed above. In one aspect of the invention, instrumented adapter 154 includes all the detection, signal processing, data processing, and control software, instrumentation, and hardware needed to control the operation of drill 152, specifically, the operation of drill bit 156.

FIG. 14 is a perspective view of instrumented adapter 154 shown in FIG. 13. FIG. 15 is a plan view of the instrumented adapter 154 shown in FIG. 14. FIG. 16 is a right side elevation view of instrumented adapter 154 shown in FIG. 15 as viewed along lines 16-16. FIG. 17 is a left side elevation view of instrumented adapter 154 shown in FIG. 15 as viewed along lines 17-17. As shown in FIGS. 14-17, instrumented adapter 154 includes a cylindrical main body section 162, an adjustable jaws 164 mounted to main body section 162, and a cylindrical extension 166 mounted to the main body section 162 opposite adjustable jaws 164. Jaws 164 may be conventional and may be adapted to adjust and accept drill bits having a wide range of diameters and lengths. In one aspect of the invention, jaws 164 are not adjustable and comprise a mounting for a single diameter drill bit, for example, a drill bit that correspond to the frequency or threshold parameters coded into sensor assembly 160. Cylindrical extension 166 typically comprises a means for mounting adapter 154 to a drill, for example, to drill 152. Cylindrical extension 166 may be circular or polygonal in cross section, for example, square or triangular in cross section.

Main body section 162 provides a platform for mounting sensor assembly 160. As indicated by the sensor assembly 160 shown in phantom in FIG. 15, according to one aspect of the invention, one or more sensor assemblies 160 may be mounted to main body section 162. Sensor assembly 160 may be mounted on the surface of main body section, embedded in the surface of main body section, or positioned within main body section 162. For example, in one aspect, sensor assembly 160 may be mounted in a cavity in main body section that may be accessible though disassembly or via a removable cover. In one aspect of the invention, main body section 162 may comprise passages for passing wires from upon or within main body section 162 to an external receiver. In another aspect of the invention, main body section may include an antenna for transmitting signals from sensor assembly 160 to an external receiver. In one aspect of the invention, sensor assembly 160 may be adapted to receive one or more signals telemetrically, for example, to receive frequency specification for a filter or a threshold value. In one aspect of the invention, main body section may also include the break or clutch assembly, discussed above, for controlling the rotation of jaws 164 and the rotation of drill bit 156 mounted therein. Thought main body section 162 is shown circular cylindrical in FIGS. 14-17, main body section 162 may also be non-circular in cross section, for example, square or triangular in cross section.

Instrumented adapter or chuck 154 has a diameter 168 and a length 170. Though diameter 168 and length 170 may vary broadly depending upon the size of drill 152 and drill bit 156, in one aspect of the invention, diameter 168 may be between about 0.25 inches and about 2 feet, for example, between about 1 inch and about 6 inches. Similarly, in one aspect of the invention, length 170 may be between about 1 inch and about 6 feet, for example, between about 3 inches and about 12 inches.

Instrumented adapter 154 may be metallic or non-metallic. For example, adapter 154 may be made from steel, stainless steel, tool steel, aluminum, titanium, brass, or any other structural metal; or adapter 154 may be made from polyethylene (PE), polypropylene (PP), polyester (PE), polytetraflouroethylene (PTFE), acrylonitrile butadiene styrene (ABS), among other plastics. Adapter 154 may be fabricated or machined from a stock shape, cast, forged, or fabricated by welding, gluing, or mechanical fasteners, among other methods.

Though FIGS. 13-17 illustrate aspects of the present invention drawn to a drill and drilling, it will be readily apparent to those of skill in the art, that aspects of the invention are applicable to any operation having tooling from which an operational parameter can be detected and analyzed, for example, any one of the tools and tooling operations mentioned previously.

Though the trials discussed above were directed toward the detection and analyzis of the acceleration (that is, vibration) of a tool during the drilling of materials of different densities, most notably, the surgical drilling of bone, the inventors recognize that aspects of the invention may be applicable to the operation and control of any tool in any environment by monitoring any operational parameter. For example, tools used for drilling, sawing, reaming, shaping, planning, turning, boring, milling, broaching, and grinding, among others, may be used, operated, or controlled according to aspects of the presenting invention. According to aspects of the invention, any one of these tools may operated or controlled in an industrial or residential environment. Aspects of the invention may be applied to the manual or automated operation of a tool, for example, remote operation by means of a robotic actuator or in applications employing haptic devices. Furthermore, the operational parameter that may be monitored according to aspects of the invention may include one or more of linear displacement, speed, or acceleration; rotational displacement, speed, or acceleration; force; torque; amperage, voltage, and sound.

According to one aspect of the invention, the operational parameter detected by the sensor, for example, sensor 20, sensor 36, or sensor assembly 160, may be sound. In this aspect of the invention, the sensor may comprise a microphone mounted on, in, or adjacent to the tool. The microphone may comprise any device adapted to sense sound waves emitted by the tool, for example, due to the action of the tool on the work piece, and to emit at least one signal representative of the sound waves, with or without wires. This signal may be processed and used to control the operation of the tool in any one or more of manners disclosed herein. For example, the signal emitted by the microphone may be processed to provide one or more sound frequency spectra, for example, filtered sound spectra. These spectra may be analyzed to identify resonant frequencies or characteristics of the resonant frequencies for which, for example, a threshold value may be determined. Similar to other aspects of the invention, the sound signal emitted by the microphone may be used to detect a transition in the work piece, to identify the material of the work piece, or to detect a change in the condition of the tool or the condition of the work piece, among other conditions.

Aspects of the present invention may be used to limit or prevent a tool from penetrating or breaking through a material or surface. For example, by preventing a tool from penetrating a surface, deburring of the resulting penetration may be avoided. Also, an instrumented tool according to aspects of the present invention may be used in aerospace applications, for example, when machining airplanes or spacecraft (that is, in-flight or on the ground) to minimize or prevent the penetration of enclosures, for example, under-pressurized or over-pressurized enclosures, such as, pressure-controlled cabins. In another aspect of the invention, an instrumented tool according to aspects of the present invention may be used in naval operations, for example, when machining in or on a vessel, such as a surface ship or submarine. For instance, aspects of the present invention may be used to minimize the sound of machining operations, such as, drilling, to minimize or eliminate the potential for detection. Specifically, the acceleration PSD for a tool may be monitored to control the vibration below a predetermined threshold to limit the concomitant sound emitted by a tool during a machining operation.

Aspects of the present invention may also be used for residential or home use to, for example, minimize the potential for or prevent a tool penetrating a material, for example, sheet rock, masonry, a wood or metal stud, a pipe, a wire or cable, or the enclosure of an electrical box.

Aspects of the present invention provide devices and methods for instrumenting a tool. As will be appreciated by those skilled in the art, features, characteristics, and/or advantages of the various aspects described herein, may be applied and/or extended to any embodiment (for example, applied and/or extended to any portion thereof).

Although several aspects of the present invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1. A system for controlling operation of a tool, the system comprising:
a sensor adapted to detect at least one operational parameter of the tool and outputting at least one signal representing the at least one operational parameter;
means for processing the at least one signal to detect at least one frequency of the operational parameter; and
means for controlling the operation of the tool in response to the at least one frequency of the operational parameter.

2. The system as recited in claim 1, wherein the at least one frequency comprises a plurality of frequencies.

3. The system as recited in claim 2, wherein the plurality of frequencies comprises a range of frequencies.

4. The system as recited in claim 1, wherein the means for processing the at least one signal to detect the at least one frequency comprises software adapted to determine the frequency of the at least one operational parameter.

5. The system as recited in claim 1, wherein the means for controlling the operation of the tool comprises means for detecting the activity of at least one of the operational parameter and the frequency of the operational parameter.

6. The system as recited in claim 5, wherein the activity of at least one of the operational parameter and the frequency of at least one of the operational parameter comprises a numerical characteristic of at least one of the operational parameter and the frequency of the operational parameter.

7. The system as recited in claim 6, wherein the numerical characteristic comprises at least one of amplitude, mean, variance, standard deviation, and spectral energy density.

8. The system as recited in claim 5, wherein the means for controlling the operation of the tool comprises means for comparing the numerical characteristic to a threshold value for the numerical characteristic.

9. The system as recited in claim 1, wherein the means for controlling the operation of the tool comprises at least one of means for stopping the operation of the tool, means to slow the advancement of the tool, means for stopping the advancement of the tool, and means for moving the tool.

10. The system as recited in claim 1, wherein the tool operates on a work piece comprising a first medium and a second medium, and the means for controlling the operation of the tool comprises means for detecting a transition from the first medium to the second medium.

11. The system as recited in claim 10, wherein the means for detecting the transition from the first medium to the second medium comprise means for detecting a variation in one of the operating parameter and the frequency of the operating parameter.

12. The system as recited in claim 1, wherein the operational parameter comprises one of linear displacement, linear velocity, linear acceleration, rotation, rotational velocity, rotational acceleration, force, torque, and sound.

13. The system as recited in claim 1, wherein the tool comprises one of a drill, a saw, an awl, a reamer, a lathe, a mill, an auger, and a broach.

14. A method for controlling operation of a tool, the method comprising:
detecting at least one operational parameter of the tool;
generating a signal representing the at least one operational parameter;
processing the at least one signal to detect at least one frequency of the operational parameter; and
controlling the operation of the tool in response to the at least one frequency of the operational parameter.

15. The method as recited in claim 14, wherein processing the at least one frequency comprises processing a plurality of frequencies.

16. The method as recited in claim 14, wherein processing the at least one signal to detect the at least one frequency comprises processing the at least one signal using software adapted to determine the frequency of the at least one operational parameter.

17. The method as recited in claim 14, wherein controlling the operation of the tool comprises detecting the activity of at least one of the operational parameter and the frequency of the operational parameter.

18. The method as recited in claim 17, wherein detecting the activity of at least one of the operational parameter and the frequency of the operational parameter comprises detecting a numerical characteristic of at least one of the operational parameter and the frequency of the operational parameter.

19. The method as recited in claim 18, wherein detecting the numerical characteristic comprises detecting at least one of amplitude, mean, variance, standard deviation, and spectral energy density.

20. The method as recited in claim 18, wherein controlling the operation of the tool comprises comparing the numerical characteristic to a threshold value for the numerical characteristic.

21. The method as recited in claim 1, wherein controlling the operation of the tool comprises at least one of stopping the operation of the tool, slowing the advancement of the tool, stopping the advancement of the tool, and moving the tool.

22. The method as recited in claim 1, further comprising operating the tool on a work piece comprising a first medium and a second medium, and wherein controlling the operation of the tool comprises detecting a transition from the first medium to the second medium.

23. The method as recited in claim 22, wherein detecting the transition from the first medium to the second medium comprises detecting a variation in one of the operating parameter and the frequency of the operating parameter.

24. The method as recited in claim 14, wherein the operational parameter comprises one of linear displacement, linear velocity, linear acceleration, rotation, rotational velocity, rotational acceleration, force, torque, and sound.

25. The method as recited in claim 14, wherein the tool comprises one of a drill, a saw, an awl, a reamer, a lathe, a mill, an auger, and a broach.

26. A system for controlling operation of a surgical drill on a bone, the system comprising:
a sensor adapted to detect at least one operational parameter of the drill and outputting at least one signal representing the at least one operational parameter;
means for processing the at least one signal to detect at least one frequency of the operational parameter; and
means for controlling the operation of the surgical drill in response to the at least one frequency of the operational parameter.

27. The system as recited in claim 26, wherein the bone comprises a first medium and a second medium, and wherein the system further comprises means for detecting a transition from the first medium to the second medium.

28. The system as recited in claim 27, wherein the means for controlling the operation of the surgical drill comprises at least one of means of stopping the operation of the drill, means for slowing the advancement of the drill, means for stopping the advancement of the drill, means for retracting the drill, and means for advancing the drill.

29. The system as recited in claim 27, wherein the first medium comprises trabecular bone and the second medium comprises cortical bone.

30. The system as recited in claim 26, wherein the operational parameter comprises one of linear displacement, linear velocity, linear acceleration, rotation, rotational velocity, rotational acceleration, force, torque, and sound.

31. The system as recited in claim 26, wherein the operational parameter comprises drill bit linear acceleration, and wherein the means for controlling comprises means for controlling the operation of the drill in response to a frequency spectrum of the drill bit linear acceleration.

32. The system as recited in claim 31, wherein the means for controlling the operation of the drill in response to the frequency spectrum of the drill bit linear acceleration comprises means for controlling the operation of the drill in response to the detection of at least one predetermined frequency of the linear acceleration.

33. The system as recited in claim 32, wherein the means for controlling the operation of the drill comprises means for controlling the operation of the drill in response to activity of one of the linear acceleration and the frequency of the linear acceleration at the at least one predetermined frequency of the drill bit linear acceleration.

34. The system as recited in claim 33, wherein the activity comprises one of amplitude, mean, variance, standard deviation, and spectral energy density.

35. A method for controlling operation of a surgical drill on a bone, the method comprising:
detecting at least one operational parameter of the drill and outputting at least one signal representing the at least one operational parameter;
processing the at least one signal to detect at least one frequency of the operational parameter; and
controlling the operation of the surgical drill in response to the at least one frequency of the operational parameter.

36. The method as recited in claim 35, wherein the bone comprises a first medium and a second medium, and the method further comprises detecting a transition from the first medium to the second medium.

37. The method as recited in claim 36, wherein controlling the operation of the surgical drill comprises at least one of stopping the operation of the drill, slowing the advancement of the drill, stopping the advancement of the drill, retracting the drill, and advancing the drill.

38. The method as recited in claim 36, wherein the first medium comprises trabecular bone and the second medium comprises cortical bone.

39. The method as recited in claim 35, wherein the operational parameter comprises one of linear displacement, linear velocity, linear acceleration, rotation, rotational velocity, rotational acceleration, force, torque, and sound.

40. The method as recited in claim 35, wherein the operational parameter comprises drill bit linear acceleration, and wherein controlling the operation comprises controlling the operation of the drill in response to a frequency spectrum of the drill bit linear acceleration.

41. The method as recited in claim 40, wherein controlling the operation of the drill in response to the frequency spectrum of the drill bit linear acceleration comprises controlling the operation of the drill in response to the detection of at least one predetermined frequency of the linear acceleration.

42. The method as recited in claim 41, wherein controlling the operation of the drill comprises controlling the operation of the drill in response to activity of one of the linear acceleration and the frequency of the linear acceleration at the at least one predetermined frequency of the drill linear acceleration.

43. The method as recited in claim 42, wherein the activity comprises one of amplitude, mean, variance, standard deviation, and spectral energy density.

44. A method for controlling operation of a tool, the method comprising:
detecting an operational parameter of a tool;
determining a characterizing value of the operational parameter at a pre-defined frequency;
comparing the characterizing value to a pre-defined threshold value of the characterizing value;
controlling the operation of the tool based upon the comparison of the characterizing value to the threshold value.

45. The method as recited in claim 44, wherein the characterizing value comprises a characterizing value of one of the operational parameter and the frequency of the operational parameter.

46. The method as recited in claim 45 wherein the characterizing value comprise one of amplitude, mean, variance, standard deviation, and spectral energy density.

47. The method as recited in claim 44, wherein controlling the operation of the tool comprises at least one of stopping the operation of the tool, slowing the advancement of the tool, stopping the advancement of the tool, retracting the tool, and advancing the tool.

48. A method for identifying a material being acted on by a tool, the method comprising:
defining at least one threshold value for a characterizing value of an operational parameter at at least one frequency for at least one material;
acting on the material with the tool;
detecting an operational parameter of the tool;
determining at least one characterizing value of the operational parameter at the least one predefined frequency; and
comparing the characterizing value with the at least one threshold value to identify the material.

49. The method as recited in claim 48, wherein the characterizing value comprises one of a characterizing value of one of the operational parameter and the frequency of the operational parameter.

50. The method as recited in claim 49, wherein the characterizing value comprises one of amplitude, mean, variance, standard deviation, and spectral energy density.

51. The method as recited in claim 48, wherein defining at least one threshold for at least one material comprises defining a threshold value for a plurality of materials.

52. An instrumented adapter for a tool comprising:
a cylindrical main body;
means for mounting the tool to the cylindrical main body;
means for mounting the main body to a motive force provider for the tool; and
a sensor mounted to the cylindrical main body, the sensor adapted to detect at least one operational parameter of the tool and to output a signal representative of the at least one operational parameter.

53. The instrumented adapter as recited in claim 52, wherein the means for mounting the tool comprises an adjustable chuck.

54. The instrumented adapter as recited in claim 52, wherein the means for mounting the motive force provider to the main body comprises a cylindrical projection engagable by the motive force provider.

55. The instrumented adapter as recited in claim 52, wherein the sensor is mounted one of on and in the cylindrical main body.

56. The instrumented adapter as recited in claim 52, wherein the sensor is adapted to output a signal via one of telemetry and wires.

57. The instrumented adapter as recited in claim 52, wherein the means for mounting the main body to the motive force provider is opposite the means for mounting the tool.

58. The system as recited in claim 4, wherein the software adapted to determine the frequency of the at least one operational parameter comprises a Fourier Transform.

59. The method as recited in claim 16, wherein the software adapted to determine the frequency of the at least one operational parameter comprises a Fourier Transform.

60. The system as recited in claim 1, wherein the system further comprises means for detecting the depth of penetration of the tool.

61. The system as recited in claim 60, wherein the means for detecting the depth of penetration of the tool comprises a linear variable differential transformer.

62. The system as recited in claim 1, wherein the system further comprises means for detecting the orientation of the tool.

63. The system as recited in claim 62, wherein the means for detecting the orientation of the tool comprises one of an accelerometer and an inclinometer.
